(19) United States
(12) Patent Application Publication
(10) Pub. No.: US 2016/0364523 A1
(43) Pub. Date: Dec. 15, 2016

(54) SYSTEMS AND METHODS FOR IDENTIFYING MICROORGANISMS

(71) Applicant: Seven Bridges Genomics Inc., Cambridge, MA (US)

(72) Inventors: Devin Locke, Medford, MA (US); Piotr Szamel, Somerville, MA (US)

(21) Appl. No.: 15/007,865

(22) Filed: Jan. 27, 2016

Related U.S. Application Data
(60) Provisional application No. 62/174,208, filed on Jun. 11, 2015.

(51) Int. Cl. G06F 19/22

(52) U.S. Cl. CPC G06F 19/22

(57) ABSTRACT

The invention provides methods for identifying a microorganism by aligning sequence reads to a graph, such as a directed acyclic graph (DAG), that contains condensed sequence information of a conserved region from multiple known microorganisms. The DAG can be constructed by obtaining sequence information of known reference microorganisms. The DAG also includes the identities of the known microorganisms that correspond to particular paths. Sequence reads obtained from an unknown sample can thus be aligned to paths in the DAG using an alignment algorithm, and the identity of a microorganism in the sample can be determined based on which path in the DAG to which the sequence reads align best.

### CROSS-REFERENCE TO RELATED APPLICATIONS

This application claims priority to and the benefit of U.S. Provisional Patent Application Ser. No. 62/174,208, filed Jun. 11, 2015, the contents of which are incorporated by reference.

### SEQUENCE LISTING

This application contains a sequence listing which has been submitted in ASCII format via EFS-Web and is hereby incorporated by reference in its entirety. The ASCII-formatted sequence listing, created on Jan. 27, 2016, is named SBG-017-01US-Seqs_ST25, and is 1,787 bytes in size.

### FIELD OF THE INVENTION

The invention relates to identifying unknown microorganisms.

### BACKGROUND

Anthrax is a deadly disease caused by the bacterium Bacillus anthracis. Anthrax spores can enter the human body through ingestion or inhalation, and even small amounts can be lethal. Public safety requires the ability to distinguish Anthrax from common and more innocuous microbes such as Bacillus megaterium when strange materials are found in airports or the mail. Identifying microorganisms is particularly challenging, however, because they are extremely diverse. For example, some estimate that there are more than a billion bacterial species in existence.

One method for identifying a microorganism includes isolation and culturing followed by biochemical testing. However, isolation and culturing can require days and is not always successful. Alternatively, sequencing can be used to determine the sequence of nucleic acids present in a sample, which can avoid the requirement of isolation and culturing. Such approaches typically target a conserved gene. For example, the 16S rRNA gene is present in all known cellular organisms and contains a favorable mix of highly conserved regions and hypervariable regions. A gene with those characteristics can be used to identify an unknown organism by comparing the sequence to sequences from the same gene from known organisms (e.g., by aligning to those known sequences and identifying disparities). However, such a comparison is computationally prohibitive due to the vast amount of reference sequence available. For example, existing 16S rRNA databases contain nearly every known sequence including sequence from uncultured organisms. Since a typical pairwise alignment between just two sequences involves inserting gaps into each sequence and adjusting how the characters line up to create every hypothetically possible alignment subject to a few heuristic constraints, and calculating a match score for each of those thousands or millions of combinations, to test an unknown organism against the entire reference set of all known organisms is computationally prohibitive. Real-world circumstances typically require the ability to immediately determine what microbe is present in a sample, and exhaustive searches of existing databases are not always an acceptable option.

### SUMMARY

The invention provides methods of identifying a microorganism by aligning a sequence from an unknown organism to a graph, such as a directed acyclic graph (DAG), that contains condensed sequence information of a conserved region from multiple known microorganisms. By aligning to the DAG, the unknown sequence is effectively compared to many known sequences in a single, efficient operation, avoiding the requirement for a pairwise alignment to each and every entry in a reference database. Additionally, aligning to a DAG avoids misleading inferences made by independently aligning to each linear reference. The DAG can be constructed initially by obtaining sequence information of known reference microorganisms. Obtaining the sequence information can include sequencing genes to build the DAG, obtaining known sequences from databases or the literature, or combinations thereof. The sequences are transformed into a graph structure in which nodes are connected by edges. The nodes may represent known sequences, using a single node to represent a portion of a sequence that is shared among a plurality of known microorganisms, with the edges connecting the nodes, such that a path of nodes and edges through the DAG corresponds to the sequence of a known microorganism (alternatively, the sequence data can be stored in the edges with the nodes representing connections from one sequence to another). The DAG also includes the identities of the known microorganisms in association with the particular paths that represent the sequences of the conserved gene for those organisms. Some portions of the paths correspond to only one microorganism, and others correspond to multiple microorganisms. A sequence obtained from an unknown sample can thus be aligned to a portion of the DAG, and the identity of a microorganism in the sample can be determined based on finding an optimal-scoring alignment between the sequence from the unknown organism and at least a portion of a path in the DAG. In some cases, one or more paths are identified to which the sequences align, and the species corresponding to the one or more paths is or are determined. During alignment, novel sequences from the sample may be incorporated into the DAG as new nodes and edges thus building up the contents of the DAG for use as a reference in subsequent operations. Results of the alignment can be reported as a list of microorganism species that correspond to paths of the DAG meeting a certain alignment threshold, along with scores indicating the quality of the match. The report may include probabilities corresponding to the identified species or percentages of reads aligned or nucleotides matched.

Mapping to a DAG makes read assembly more successful as paths through the DAG will be a better fit than a linear reference. Additionally, unlike existing DAG databases, the present DAG only contains observed sequences. It avoids collapsing identical nucleotides at the same position from different branches into a single node. Thus it avoids adding artificial edges/nodes that do not represent actually existing sequences. Those features of the DAG make it optimal for typing because it includes all potential candidate species, and it reduces the prevalence of artificial non-candidates.

In certain aspects, the invention provides a method for identifying a microorganism. The method involves using a computer system comprising a processor coupled to a memory device for obtaining a sequence of a conserved gene for each of a plurality of microorganisms. The method also involves transforming the sequences into a directed acyclic graph (DAG) comprising nodes connected by edges, such that each microorganism is represented by a path through the DAG that contains the sequence of the conserved gene for that microorganism. The method also involves obtaining sequence reads from a sample containing nucleic acid from at least one microorganism and determining an optimal-scoring alignment between the sequence reads and at least one of the paths within the DAG. The method further involves retrieving an identity of the at least one microorganism represented by that path and providing a report that includes the identity of the at least one microorganism. The sequence reads may be obtained by sequencing nucleic acid from a sample.

In some embodiments, transforming the sequences into the DAG comprises creating the nodes using index-free adjacency wherein each node includes one pointer for each connected node to which that node is connected by an edge. In certain embodiments, each of the nodes may include an adjacency list that stores a list of edges to which that node is adjacent. Each adjacency list may include pointers to specific physical locations within the memory of the adjacent edges. Using adjacency, each pointer may identify a location of the connected node. Identifying the location of a connected node by a pointer may include identifying a physical location in the memory device where the connected node is stored. Thus, the DAG may use pointers to identify a physical location in the memory device where each node is stored.

In embodiments, the plurality of microorganisms includes at least 25,000 distinct microorganisms and the DAG contains paths representing the sequence of the conserved gene for each of the at least 25,000 organisms. In certain embodiments, the DAG includes paths representing sequences of the conserved genes for at least 250,000 organisms. The DAG may represent different species of microbes and/or different strains of species. Determining the optimal-scoring alignment between the sequence reads and one of the paths within the DAG may include comparing the sequence reads to each sequence of the conserved gene for each of the at least 25,000 or 250,000 organisms. The conserved gene may be a 16S rRNA gene. Obtaining the sequence of the conserved gene for each of the plurality of microorganisms may include retrieving sequence data from an online database.

Determining the optimal-scoring alignment may include calculating match scores between bases of the sequence reads and bases in the paths, and looking backwards to predecessor bases in the candidate paths to identify a backtrack through the paths that gives an optimal score. The backtrack that gives the optimal score may correspond to the optimally-scoring alignment of the sequence reads to the paths.

In certain embodiments, the report may include identities and alignment scores of all microorganisms that meet an alignment score threshold.

In related aspects, the invention provides a computer system operable to identify a microorganism. The system includes a processor coupled to a memory device for obtaining a sequence of a conserved gene for each of a plurality of microorganisms. The system is operable to transform the sequences into a directed acyclic graph (DAG) comprising nodes connected by edges, such that each microorganism is represented by a path through the DAG that contains the sequence of the conserved gene for that microorganism. The computer system is further operable to obtain sequence reads from a sample containing nucleic acid from at least one microorganism and determine an optimal-scoring alignment between the sequence reads and at least one of the paths within the DAG. The system is further operable to retrieve an identity of the at least one microorganism represented by that path and provide a report that includes the identity of the at least one microorganism. The sequence reads may be obtained by sequencing nucleic acid from a sample.

In some embodiments of the system, transforming the sequences into the DAG comprises creating the nodes using index-free adjacency wherein each node includes one pointer for each connected node to which that node is connected by an edge. In certain embodiments, each of the nodes may include an adjacency list that stores a list of edges to which that node is adjacent. Each adjacency list may include pointers to specific physical locations within the memory of the adjacent edges. Using adjacency, each pointer may identify a location of the connected node. Identifying the location of a connected node by a pointer may include identifying a physical location in the memory device where the connected node is stored. Thus, the DAG may use pointers to identify a physical location in the memory device where each node is stored.

In embodiments of the system, the plurality of microorganisms includes at least 25,000 distinct microorganisms and the DAG contains paths representing the sequence of the conserved gene for each of the at least 25,000 organisms. In certain embodiments, the DAG includes paths representing sequences of the conserved genes for at least 250,000 organisms. The DAG may represent different species of microorganisms and/or different strains of species. Determining the optimal-scoring alignment between the sequence reads and at least one of the paths within the DAG may include comparing the sequence reads to each sequence of the conserved gene for each of the at least 25,000 or 250,000 organisms. The conserved gene may be a 16S rRNA gene. Obtaining the sequence of the conserved gene for each of the plurality of microorganisms may include retrieving sequence data from an online database.

Determining the optimal-scoring alignment may include calculating match scores between bases of the sequence reads and bases in the paths, and looking backwards to predecessor bases in the candidate paths to identify a backtrack through the paths that gives an optimal score. The backtrack that gives the optimal score may correspond to the optimally-scoring alignment of the sequence reads to the paths.

In certain embodiments, the report may include identities and alignment scores of all microorganisms that meet an alignment score threshold.

### BRIEF DESCRIPTION OF THE DRAWINGS

FIG. 1 illustrates creation of a DAG.

FIG. 2 shows one possible format of a DAG.

FIG. 3 shows a formation of a DAG.

FIG. 4 shows a formation of a DAG.

FIG. 5 describes mapping a sequence read to a DAG.

FIG. 6 shows matrices used in aligning a sequence to a DAG.

FIG. 7 shows a part of a hypothetical DAG with a path identified.

FIG. 8 shows a sample table identifying specific microorganisms.

FIG. 9 illustrates a method of the invention.

FIG. 10 illustrates a system of the invention.

### DETAILED DESCRIPTION

In general, the invention provides systems and methods for typing a microorganism. The invention involves constructing a reference graph, such as a directed acyclic graph (DAG), containing sequence information from multiple known microorganism references. The reference data can be collected from freely available online sources that compile sequencing data from labs around the world. The data can be from a particular conserved nucleotide sequence such as a conserved gene. A conserved gene found in all bacteria, for example, is useful because it allows all known organisms with that gene to be included in the DAG. A conserved gene such as 16S rRNA is particularly beneficial for use with the invention because it contains both highly conserved regions and highly variable regions, and therefore is a preferred gene for phylogenetic studies. Additionally, a conserved gene such as 16S rRNA is useful because conserved primers are known that can be used to capture, amplify, or sequence 16S rRNA in an unknown organism. The reference data is compressed in the DAG into nodes and edges, which define observed sequences and the connections between them. The sequence of a particular known microorganism may be represented by an individual path through the DAG. DAG edges are treated as independent of one another, meaning that paths that do not represent known microorganisms may exist. However, unnecessary artificial paths are prevented by not collapsing identical nucleotides at the same position from different branches into a single node. Some branches in the paths correspond to only one microorganism, and others correspond to multiple microorganisms. Sequence information from a sample can be obtained and aligned to a path in the DAG. The DAG also contains the identities of the microorganisms so that when sequence reads are aligned to a portion of the DAG, a report can be generated that indicates which microorganism or microorganisms corresponds to the paths to which the sequences aligned. The report indicates one or more microorganisms that are present in the sample. The report may include all paths against which the sequence alignment met a certain threshold. The report may also provide scores and percentages indicating how closely the sample sequences aligned, how accurate the match is, and what proportion of reads aligned to each path.

By aligning to a DAG, sequence reads are compared to more than just a limited, linear reference. Sequence reads are compared to a variety of known variants all at once, avoiding the requirement of an exhaustive pairwise alignment between the unknown sequence and each known sequence in the reference data set. Additionally, by aligning to a DAG instead of a linear reference, misleading inferences made by aligning to a single reference are avoided. Furthermore, novel sequences from the sample can be incorporated into the DAG as new nodes and edges, thereby constantly increasing the robustness of the DAG.

Systems and methods according to the disclosure are particularly useful for metagenomics analyses, in which an environmental sample is characterized by the diversity of its bacterial population. Samples may be selected from ecological sites, such as seawater, rivers, sewage, and the like. The profile of bacteria from an environmental sample can help explain a variety of underlying processes. Similarly, samples may also be selected from physiological sites, such as portions of the digestive system. There is evidence that bacterial populations may contribute to various intestinal disorders, and metagenomics analyses can be used to identify particular profiles associated with disease. Nucleic acids may be isolated from a sample and then sequenced using PCR directed sequencing, “shotgun” whole genome sequencing, or other methods. Sequence reads are then aligned to a reference or other structure to “type” the microorganisms within a sample.

Methods of the invention involve identifying or typing a microorganism based on aligning sequence reads from the 16S rRNA gene sequence against a DAG reference. 16S rRNA is a component of the 30S small subunit of prokaryotic ribosomes. Multiple sequences of 16S rRNA can exist within a single bacterium. The invention takes advantage of the presence of highly conserved primer binding sites and the slow rates of evolution of 16S rRNA to identify microorganisms. In certain embodiments, other conserved sequences may be used, such as 18S rRNA, for example.

In addition to highly conserved regions, 16S rRNA gene sequences contain hypervariable regions. The invention utilizes those regions to uniquely identify microorganisms based on their species-specific signature sequences. The invention provides a rapid and accurate method for bacterial identification. The invention is further applicable to reclassifying known bacteria into new species and genera, or even classifying unknown species that have never been successfully cultured.

The invention utilizes a DAG built from reference sequences from a conserved gene from multiple species. The DAG may, for example, represent the 16S rRNA sequences of a subset of microorganisms or all known microorganisms. It may include previously-unidentified or unknown microbes. The DAG is particularly useful because it employs all relevant candidate species of microbes, thereby providing the most complete and accurate identification of a microbe of interest. In order to handle the massive computational challenge, the DAG makes use of several features described in greater detail below.

The DAG includes a record of which paths correspond to which reference microorganism species. Some paths may correspond to more than one species. Reads from the 16S rRNA gene of a microbe of interest can be aligned to the DAG using any appropriate alignment algorithm known in the art. In some cases, a single path is identified to which the sequences align, and the species corresponding to that path is determined. The DAG can also report probabilities when more than one species is a possible fit based on the sequence reads. The DAG can report, for example, a list of the microorganism species corresponding to the identified path, along with the percentage of reads aligned or percentage of nucleotides matched to each. The DAG may additionally weigh paths (and thus species) according to the difference between the branch and the next-best alignment for a given read.

The invention is useful for typing a microorganism. A microorganism is any microscopic living organism, which may be single celled or multicellular. Microorganisms include bacteria, archaea, and protozoa, as well as some fungi, algae, and other organisms.

In order to effectively type microorganisms, the invention makes use of conserved genes. Conserved genes are regions of nucleic acid that are similar or identical across many species. A conserved gene such as 16S rRNA is particularly useful with the invention because it is highly conserved and it also has highly variable regions, making it a good indicator of phylogenetic relationships. In addition to 16S rRNA, the invention can use any other conserved gene to type microorganisms. Throughout the application, reference will be made to the 16S rRNA gene as an exemplary conserved gene for use with the invention. Nevertheless, it should be understood that the invention includes building and aligning to a DAG containing sequence data from other conserved genes as well.

In certain embodiments, sequencing reads are obtained by performing sequencing on a sample from a microbe of interest. Sequencing may be by any method known in the art. See, generally, Quail, et al., 2012, A tale of three next generation sequencing platforms: comparison of Ion Torrent, Pacific Biosciences and Illumina MiSeq sequencers, BMC Genomics 13:341. DNA sequencing techniques include classic dideoxy sequencing reactions (Sanger method) using labeled terminators or primers and gel separation in slab or capillary. Other sequencing methods include the various next-generation sequencing (NGS) techniques, including sequencing by synthesis using reversibly terminated labeled nucleotides, pyrosequencing, 454 sequencing, Illumina/Solexa sequencing, real time monitoring of the incorporation of labeled nucleotides during a polymerization step, polony sequencing, and SOLiD sequencing. Separated molecules may be sequenced by sequential or single extension reactions using polymerases or ligases as well as by single or sequential differential hybridizations with libraries of probes.

A sequencing technique that can be used includes, for example, use of sequencing-by-synthesis systems sold under the trademarks GS JUNIOR, GS FLX+ and 454 SEQUENCING by 454 Life Sciences, a Roche company (Branford, Conn.), and described by Margulies, M. et al., Genome sequencing in micro-fabricated high-density picotiter reactors, Nature, 437:376-380 (2005); U.S. Pat. No. 5,583,024; U.S. Pat. No. 5,674,713; and U.S. Pat. No. 5,700,673, the contents of which are incorporated by reference herein in their entirety. 454 sequencing involves two steps. In the first step of those systems, DNA is sheared into fragments of approximately 300-800 base pairs, and the fragments are blunt ended. Oligonucleotide adaptors are then ligated to the ends of the fragments. The adaptors serve as primers for amplification and sequencing of the fragments. The fragments can be attached to DNA capture beads, e.g., streptavidin-coated beads using, e.g., Adaptor B, which contains 5′-biotin tag. The fragments attached to the beads are PCR amplified within droplets of an oil-water emulsion. The result is multiple copies of clonally amplified DNA fragments on each bead. In the second step, the beads are captured in wells (pico-liter sized). Pyrosequencing is performed on each DNA fragment in parallel. Addition of one or more nucleotides generates a light signal that is recorded by a CCD camera in a sequencing instrument. The signal strength is proportional to the number of nucleotides incorporated. Pyrosequencing makes use of pyrophosphate (PPi) which is released upon nucleotide addition. PPi is converted to ATP by ATP sulfurylase in the presence of adenosine 5′ phosphosulfate. Luciferase uses ATP to convert luciferin to oxyluciferin, and this reaction generates light that is detected and analyzed.

Another example of a sequencing technique that can be used is SOLiD technology by Applied Biosystems from Life Technologies Corporation (Carlsbad, Calif.). In SOLiD sequencing, genomic DNA is sheared into fragments, and adaptors are attached to the 5′ and 3′ ends of the fragments to generate a fragment library. Alternatively, internal adaptors can be introduced by ligating adaptors to the 5′ and 3′ ends of the fragments, circularizing the fragments, digesting the circularized fragment to generate an internal adaptor, and attaching adaptors to the 5′ and 3′ ends of the resulting fragments to generate a mate-paired library. Next, clonal bead populations are prepared in microreactors containing beads, primers, template, and PCR components. Following PCR, the templates are denatured and beads are enriched to separate the beads with extended templates. Templates on the selected beads are subjected to a 3′ modification that permits bonding to a glass slide. The sequence can be determined by sequential hybridization and ligation of partially random oligonucleotides with a central determined base (or pair of bases) that is identified by a specific fluorophore. After a color is recorded, the ligated oligonucleotide is removed and the process is then repeated.

Another example of a sequencing technique that can be used is ion semiconductor sequencing using, for example, a system sold under the trademark ION TORRENT by Ion Torrent by Life Technologies (South San Francisco, Calif.). Ion semiconductor sequencing is described, for example, in Rothberg, et al., An integrated semiconductor device enabling non-optical genome sequencing, Nature 475:348-352 (2011); U.S. Pubs. 2009/0026082, 2009/0127589, 2010/0035252, 2010/0137143, 2010/0188073, 2010/0197507, 2010/0282617, 2010/0300559, 2010/0300895, 2010/0301398, and 2010/0304982, the content of each of which is incorporated by reference herein in its entirety. In ion semiconductor sequencing, DNA is sheared into fragments of approximately 300-800 base pairs, and the fragments are blunt ended. Oligonucleotide adaptors are then ligated to the ends of the fragments. The adaptors serve as primers for amplification and sequencing of the fragments. The fragments can be attached to a surface and are attached at a resolution such that the fragments are individually resolvable. Addition of one or more nucleotides releases a proton (H⁺), which signal is detected and recorded in a sequencing instrument. The signal strength is proportional to the number of nucleotides incorporated.

Another example of a sequencing technology that can be used is Illumina sequencing. Illumina sequencing is based on the amplification of DNA on a solid surface using fold-back PCR and anchored primers. Genomic DNA is fragmented, and adapters are added to the 5′ and 3′ ends of the fragments. DNA fragments that are attached to the surface of flow cell channels are extended and bridge amplified. The fragments become double stranded, and the double stranded molecules are denatured. Multiple cycles of the solid-phase amplification followed by denaturation can create several million clusters of approximately 1,000 copies of single-stranded DNA molecules of the same template in each channel of the flow cell. Primers, DNA polymerase and four fluorophore-labeled, reversibly terminating nucleotides are used to perform sequential sequencing. After nucleotide incorporation, a laser is used to excite the fluorophores, and an image is captured and the identity of the first base is recorded. The 3′ terminators and fluorophores from each incorporated base are removed and the incorporation, detection and identification steps are repeated. Sequencing according to this technology is described in U.S. Pub. 2011/0009278, U.S. Pub. 2007/0114362, U.S. Pub. 2006/0024681, U.S. Pub. 2006/0292611, U.S. Pat. No. 7,960,120, U.S. Pat. No. 7,835,871, U.S. Pat. No. 7,232,656, U.S. Pat. No. 7,598,035, U.S. Pat. No. 6,306,597, U.S. Pat. No. 6,210,891, U.S. Pat. No. 6,828,100, U.S. Pat. No. 6,833,246, and U.S. Pat. No. 6,911,345, each of which are herein incorporated by reference in their entirety.

Another example of a sequencing technology that can be used includes the single molecule, real-time (SMRT) technology of Pacific Biosciences (Menlo Park, Calif.). In SMRT, each of the four DNA bases is attached to one of four different fluorescent dyes. These dyes are phospholinked. A single DNA polymerase is immobilized with a single molecule of template single stranded DNA at the bottom of a zero-mode waveguide (ZMW). A ZMW is a confinement structure which enables observation of incorporation of a single nucleotide by DNA polymerase against the background of fluorescent nucleotides that rapidly diffuse in and out of the ZMW (in microseconds). It takes several milliseconds to incorporate a nucleotide into a growing strand. During this time, the fluorescent label is excited and produces a fluorescent signal, and the fluorescent tag is cleaved off. Detection of the corresponding fluorescence of the dye indicates which base was incorporated. The process is repeated.

Another example of a sequencing technique that can be used is nanopore sequencing. See Soni and Meller, 2007 Clin Chem 53: 1996-2001. A nanopore is a small hole, of the order of 1 nanometer in diameter. Immersion of a nanopore in a conducting fluid and application of a potential across it results in a slight electrical current due to conduction of ions through the nanopore. The amount of current which flows is sensitive to the size of the nanopore. As a DNA molecule passes through a nanopore, each nucleotide on the DNA molecule obstructs the nanopore to a different degree. Thus, the change in the current passing through the nanopore as the DNA molecule passes through the nanopore represents a reading of the DNA sequence.

Sequencing generates a plurality of reads. Reads generally include sequences of nucleotide data less than about 600 or 700 bases in length and methods of the invention may be applicable to reads or sequence information of any length including, e.g., reads of <150 bases or even less than 50, as well as greater than 700, e.g., thousands of bases in length. Typically, NGS reads are either mapped to a reference or assembled de novo and analyzed. Methods of the invention include mapping NGS reads to a reference that is a directed acyclic graph (DAG) or similar data structure comprising a conserved gene such as 16S rRNA. A DAG can represent reference data as well as incoming sequence reads. In such a data structure, observed features (e.g., sequences and subsequences) from the reference conserved genes are represented as nodes, which are connected by edges.

Aspects of the invention relate to creation of a DAG that includes sequences from one or more known references. A DAG is understood in the art to refer to data that can be presented as a graph as well as to a graph that presents that data. The invention provides methods for storing a DAG as data that can be read by a computer system for bioinformatic processing or for presentation as a graph. A DAG can be saved in any suitable format including, for example, a list of nodes and edges, a matrix or a table representing a matrix, an array of arrays or similar variable structure representing a matrix, in a language built with syntax for graphs, in a general markup language purposed for a graph, or others.

In some embodiments, a DAG is stored as a list of nodes and edges. One such way is to create a text file that includes all nodes, with an ID assigned to each node, and all edges, each with the node ID of starting and ending node. Thus, for example, were a DAG to be created for two sentences, “See Jane run,” and “Run, Jane run,”, a case-insensitive text file could be created. Any suitable format could be used. For example, the text file could include comma-separated values. Naming this DAG “Jane” for future reference, in this format, the DAG “Jane” may read as follows: 1 see, 2 run, 3 jane, 4 run, 1-3, 2-3, 3-4. One of skill in the art will appreciate that this structure is easily applicable to genetic sequences, and the accompanying discussion below.

In certain embodiments, a DAG is stored as a table representing a matrix (or an array of arrays or similar variable structure representing a matrix) in which the (i,j) entry in the N×N matrix denotes whether node i and node j are connected (where N is a vector containing the nodes in genomic order). For the DAG to be acyclic simply requires that all non-zero entries be above the diagonal (assuming nodes are represented in genomic order). In a binary case, a 0 entry represents that no edge is exists from node i to node j, and a 1 entry represents an edge from i to j. One of skill in the art will appreciate that a matrix structure allows values other than 0 to 1 to be associated with an edge. For example, any entry may be a numerical value indicating a weight, or a number of times used, reflecting some natural quality of observed data in the world. A matrix can be written to a text file as a table or a linear series of rows (e.g., row 1 first, followed by a separator, etc.), thus providing a simple serialization structure.

One useful way to serialize a matrix DAG would be to use comma-separated values for the entries, after defining the nodes. Using this format, the DAG “Jane” would include the same node definitions as for above, followed by matrix entries. This format could read as:

1 see, 2 run, 3 jane, 4 run

,,1,\,,1,\,,,1\,,,

where entries of zero (0) are simply omitted and ‘\’ is a newline character.

Embodiments of the invention include storing a DAG in a language built with syntax for graphs. For example, The DOT Language provided with the graph visualization software packages known as Graphviz provides a data structure that can be used to store a DAG with auxiliary information and that can be converted into graphic file formats using a number of tools available from the Graphviz web site. Graphviz is open source graph visualization software. Graph visualization is a way of representing structural information as diagrams of abstract graphs and networks. It has applications in networking, bioinformatics, software engineering, database and web design, machine learning, and in visual interfaces for other technical domains. The Graphviz layout programs take descriptions of graphs in a simple text language, and make diagrams in useful formats, such as images and scalable vector graphics for web pages; PDF or Postscript for inclusion in other documents; or display in an interactive graph browser.

In related embodiments, a DAG is stored in a general markup language purposed for a graph. Following the descriptions above of a linear text file or a comma-separated matrix, one of skill in the art will recognize that a language such as XML can be used (extended) to create labels (markup) defining nodes and their headers or IDs, edges, weights, etc. However a DAG is structured and stored, embodiments of the invention involve using nodes to represent observed sequences with edges connecting the nodes to create paths through the DAG that represent the conserved gene sequence from a particular reference microorganism.

In a preferred embodiment, a library is developed that provides core elements of genome graph representation as well as manipulation routines. For example, library elements can be developed in a language that provides for low-level memory manipulation such as C++ and compiled to provide binary elements. A DAG may be represented as a set of edge and node objects linked to each other.

The DAG can be created by compiling sequence data from known references. The DAG can scour one or more of the many online reference databases that are freely available and which contain sequencing data collected from scientific experiments, published literature, high-throughput experiment technology, and computational analysis. Systems and methods of the invention can be used to compile sequence data from those databases into the DAG, as most databases allow users to browse and download the data. Data contained in those databases includes gene sequences, textual descriptions, attributes and ontology classifications, citations, and tabular data. Using methods of the invention, the DAG can take the semi-structured data in those databases, which may be represented as tables, key delimited records, and XML structures, and transform it into a directed acyclic structure. The invention involves compiling the information available in those databases and condensing it into a usable DAG format.

One example of a sequence database from which the invention can collect data is GenBank. The GenBank sequence database is an open access, annotated collection of all publicly available nucleotide sequences and their protein translations. GenBank is built by direct submissions from individual laboratories, as well as from bulk submissions from large-scale sequencing centers. It includes sequences from more than 100,000 distinct organisms. GenBank is considered the most important database for research in almost all biological fields. GenBank grows at an exponential rate, doubling every 18 months. As of February 2013, it contained over 150 billion nucleotide bases in more than 162 million sequences. See Benson et al., 2013, Nucleic Acids Research 41:D36-42.

Ensembl Genomes is another database available for use with the present invention. Ensemble Genomes provides genome-scale data from non-vertebrate species. It complements the main Ensembl database (which focuses on vertebrates and model organisms) by providing genome data for bacteria, fungi, invertebrate metazoa, plants, and protists. The bacterial division of Ensembl contains all bacterial genomes that have been completely sequenced, annotated, and submitted to the International Nucleotide Sequence Database Collaboration (European Nucleotide Archive, GenBank, and the DNA Database of Japan). It contains more than 15,000 genomes. Ensembl allows manipulation, analysis, and visualization of genome data. Most Ensembl Genomes data is stored in MySQL relational databases and can be accessed by the Ensembl Pearl API, virtual machines or online. See Kersey et al., 2011, Nucleic Acids Research 40:D91-97.

The DNA Data Bank of Japan (DDBJ) is another sequence database. The central DDBJ resource consists of public, open-access nucleotide sequence databases including raw sequence reads, assembly information and functional annotation. It exchanges its data with European Molecular Biology Laboratory at the European Bioinformatics Institute and with GenBank at the National Center for Biotechnology Information on a daily basis. See Kodama et al., 2012, Nucleic Acids Research 40:D38-42.

Several databases focus on a particular conserved gene, such as the 16S rRNA. For example, the EzTaxon-e database is a web-based tool for identifying prokaryotes based on 16S ribosomal RNA gene sequences. EzTaxon-e is an open access database containing sequences of type strains of prokaryotic species with validly published names. The database covers not only species within the formal nomenclatural system but also phylotypes that may represent species in nature. All sequences that are held in the EzTaxon-e database have been subjected to phylogenetic analysis, which has resulted in a complete hierarchical classification system. See Kim et al., 2012, International Journal of Systematic and Evolutionary Microbiology 62:716-21.

The Ribosomal Database Project (RDP) is another database useful with the present invention. It provides aligned and annotated rRNA gene sequence data for bacterial and archaeal small subunit rRNA genes, as well as fungal large subunit rRNA genes. RDP provides tools for analysis of high-throughput data, including both single-stranded and paired-end reads. Most tools are available as open source packages for download. See Cole et al., 2014, Nucleic Acids Research 42:D633-42.

SILVA is another database providing comprehensive, quality checked, and regularly updated datasets of aligned small (16S/18S, SSU) and large subunit (23S/28S, LSU) ribosomal RNA (rRNA) sequences for bacteria, archaea and eukarya. It has an aligner tool called SINA (SILVA INcremental Aligner) that is able to accurately align sequences based on a curated SEED alignment. The aligner determines the next related sequences using an optimized Suffix Tree server. To find the optimal alignment for a new sequence up to 40 reference sequences are taken into account. The SINA tool is not useful for typing however. See Pruesse et al., 2012, Bioinformatics 28:1823-29; and Quast et al., Nucleic Acids Research 41:D590-96.

Another database useful with the present invention is Greengenes, which is a web application that provides access to 16S rRNA gene sequence alignment for browsing, blasting, probing, and downloading. The database provides full-length small-subunit (SSU) rRNA gene sequences from public submissions of archaeal and bacterial 16S rDNA sequences. It provides taxonomic placement of unclassified environmental sequences using multiple published taxonomies for each record, multiple standard alignments, and uniform sequence-associated information curated from GenBank records. See DeS antis et al., 2006, Applied and Environmental Microbiology 72:5069-72.

The DAG can accumulate sequence data from one or more references, and compress that data into a graph of nodes and edges. To represent the graph, adjacency lists may be used wherein nodes and edges are stored as physical objects. A node or edge stores lists of edges/nodes that it is adjacent to. In certain embodiments, nucleotide sequences and metadata are stored in edge objects. The usage of adjacency (e.g., adjacency lists or index-free adjacency) simplifies local graph traversal. Adjacency provides a very efficient way to represent a DAG. The reference DAG, when implemented using computer-executable instructions, can effectively leverage specifics of hardware memory addressing for creating efficient adjacency lists. For example, the implementation of a reference DAG can actually call native pointers to adjacent edge/nodes objects from the hardware level.

In certain embodiments, the library elements can include a hash table and search algorithm for efficient searching of k-mers (sequence fragments) in the graph while maintaining a very small memory footprint. Through the use of a hash table, the average cost for a lookup may be made to be independent of the number of elements stored in the table. Additionally, the hash table can be implemented to allow for arbitrary insertion or deletion of entries. Use of pointers significantly improves operation for traversing paths through the DAG to retrieve sequence strings or to perform alignments (which traversal operations have traits in common).

In the preferred embodiments using adjacency, the pointer or native pointer is manipulable as a memory address in that it points to a physical location on the memory, but also dereferencing the pointer accesses intended data. That is, a pointer is a reference to a datum stored somewhere in memory; to obtain that datum is to dereference the pointer. The feature that separates pointers from other kinds of reference is that a pointer's value is interpreted as a memory address, at a low-level or hardware level. The speed and efficiency of the DAG engine allows short-read alignments to be made to a conserved gene reference DAG containing variant data from thousands or millions of reference species samples, using commercially available, off-the-shelf desktop systems. Such a graph representation provides means for fast random access, modification, and data retrieval. The library can also include and support a universal graph genome coordinate system. The compactness of the graph representation allows the conserved gene sequence data from typical genetic databases to be held and used within the limitations of modern consumer-grade computer systems.

In some embodiments, fast random access is supported and graph object storage are implemented with index-free adjacency in that every element contains a direct pointer to its adjacent elements (e.g., as described in U.S. Pub. 2014/0280360 and U.S. Pub. 2014/0278590, incorporated by reference), which obviates the need for index look-ups, allowing traversals (e.g., as done in the modified SW alignment algorithm described herein) to be very rapid. Index-free adjacency is another example of low-level, or hardware-level, memory referencing for data retrieval (as required in alignment and as particularly pays off in terms of speed gains in the modified, multi-dimensional Smith-Waterman alignment described herein). Specifically, index-free adjacency can be implemented such that the pointers contained within elements are in-fact references to a physical location in memory.

Since a technological implementation that uses physical memory addressing such as native pointers can access and use data in such a lightweight fashion without the requirement of separate index tables or other intervening lookup steps, the capabilities of a given computer, e.g., any modern consumer-grade desktop computer, are extended to allow for full operation of a DAG containing genetic sequences culled from databases including thousands or millions of species. Thus storing graph elements (e.g., nodes and edges) using a library of objects with native pointers or other implementation that provides index-free adjacency—i.e., embodiments in which data is retrieved by dereferencing a pointer to a physical location in memory—actually improves the ability of the technology to provide storage, retrieval, and alignment for sequence information since it uses the physical memory of a computer in a particular way.

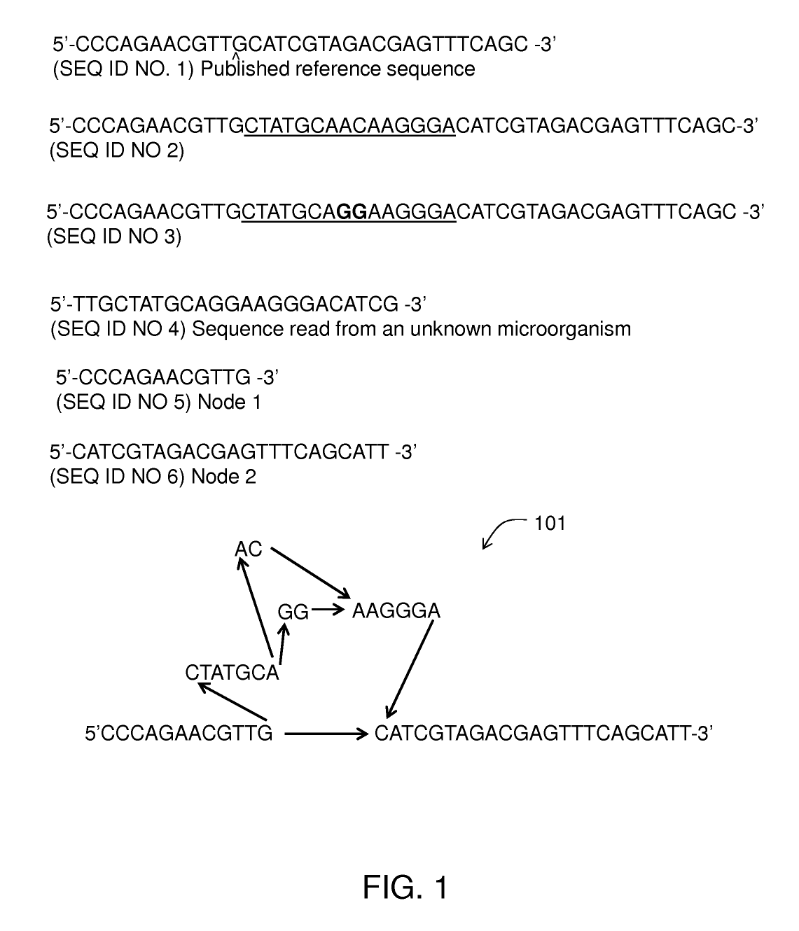

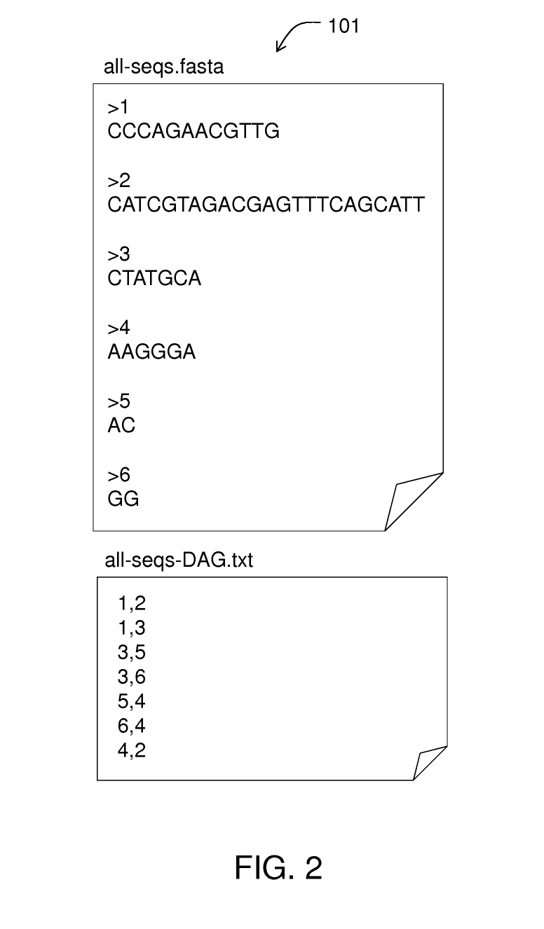

While no specific format is required for storage of a DAG, FIGS. 1 and 2 are presented to illustrate one convenient and compact format that is useful for illustrations (remembering that in a preferred embodiment graph objects are stored with index-free adjacency with metadata stored separately to speed traversals and alignments). In illustrations below, exemplary DAGs are presented and discussed as graphs, but it will be appreciated that a DAG qua graph can be translated directly to a data structure in computer memory or a text document and back.

FIG. 1 illustrates using a DAG 101 to represent and manipulate sequence data. To reveal the contents of DAG 101, FIG. 1 also includes linear listings of a set of hypothetical sequences, each of which are paths through DAG 101. A hypothetical published reference (this could be, for example, a residue from the 16S rRNA gene of E. coli) is included and has the following sequence:

(SEQ ID NO. 1)
5′-CCCAGAACGTTGCATCGTAGACGAGTTTCAGC-3′.

A second reference sequence present in the DAG is included that varies from the first sequence by a 15 by indel:

(SEQ ID NO 2)
5′-CCCAGAACGTTGCTATGCAACAAGGGACATCGTAGACGAGTTTCA
GC-3′.

A third reference sequence is also included that matches the second reference sequence but for a polymorphism in the middle of the indel at which an AC from the second reference sequence is presumptively homologous to a GG in the third reference sequence:

(SEQ ID NO 3)
5′-CCCAGAACGTTGCTATGCAGGAAGGGACATCGTAGACGAGTTTCA
GC-3′.

A hypothetical sequence read from an unknown microorganism of interest is included:

(SEQ ID NO 4)
5′-TTGCTATGCAGGAAGGGACATCG-3′.

In the depicted scenario, the unknown microorganism has the GG polymorphism. If the sequence read was aligned to the published reference sequence, it would not be discovered that the GG polymorphism represented two consecutive substitutions relative to the second reference sequence. Instead, many existing alignment or assembly algorithms would find no good alignment between the sequence read and the published reference and may even discard that read as failing to satisfy a quality criterion. Therefore under existing methods, the microorganism may not be identified.

Under methods of the invention, a DAG 101 is constructed. Node 1 is instantiated as 5′-CCCAGAACGTTG-3′ (SEQ ID NO 5). Node 2 is created as 5′-CATCGTAGACGAGTTTCAGCATT-3′ (SEQ ID NO 6). Node 3 is CTATGCA. Node 4 is AAGGGA. Node 5 is AC and node 6 is GG. It is worth noting that in some embodiments, mapping reads to a DAG involves creating a new node to represent data in the reads not yet in the DAG.

For example, prior to read mapping, DAG 101 may not yet include node 6 (GG). The alignment algorithm (discussed below) finds that the sequence reads best matches the path for the second reference sequence that connects nodes 1→3→5→4→2, as depicted in FIG. 1. To correctly represent the sequence read, new node 6 is created, and the sequence read is thus represented within DAG 101 by the path that connects nodes 1→3→6→4→2. It will be appreciated that prior to this mapping, nodes 3, 5, and 4 need not yet exist as separate nodes. Mapping the read and creating the new node 6 can include breaking up a prior node of (3+5+4) into nodes 3, 5, and 4. That is one of the powerful benefits of using a DAG as a reference—read mapping is not a simple exercise in comparison to a reference, but can include building the reference to represent all observed sequences, including novel genotypes only yet documented by new sequence reads.

FIG. 2 shows one possible format of DAG 101 suited to computational storage and retrieval. DAG 101 as represented in FIG. 2 presents the same topology and sequences as the graphical version depicted in FIG. 1. Here, the depicted format is useful because the nodes are stored as a FASTA file, which is familiar in the art of bioinformatics (and could just as easily be a FASTQ file). The edges can be stored in a text file, here as a simple list. As shown in this embodiment, each pair in the list “all-seqs-DAG.txt” represents an edge connecting two nodes.

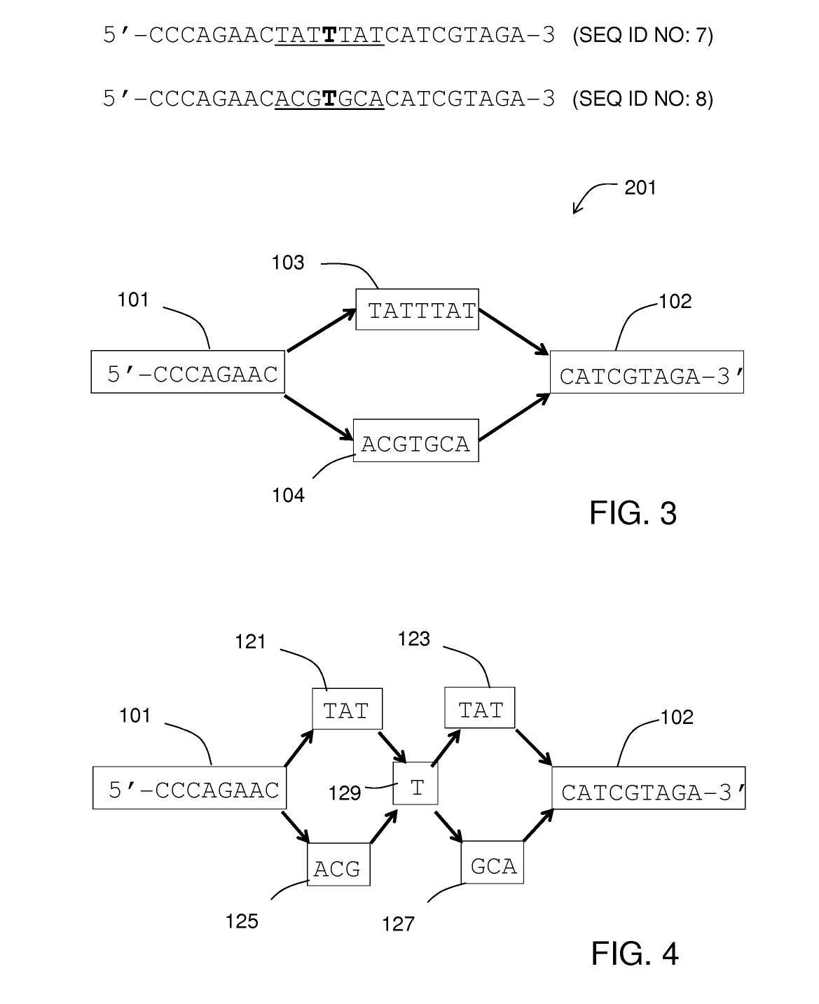

The invention further streamlines computational analysis by only including observed sequences in the DAG, thereby removing artificial sequences from the analysis. In other words, the DAG avoids creating artificial nodes and edges where two observed sequences have a nucleotide match, if those nodes/edges do not represent actually existing sequences. Some prior art DAGs (such as the SINA tool available with the SILVA database described above) collapse identical nucleotides at the same position from different branches into a single node. The difference between the DAG of the invention and some prior art DAGs is illustrated in FIGS. 3A and 3B.

FIG. 3 shows a part of a DAG containing two reference sequences at a given locus 201:

(SEQ ID NO. 7)
5′-CCCAGAACTATTTATCATCGTAGA-3′;
and
(SEQ ID NO. 8)
5′-CCCAGAACACGTGCACATCGTAGA-3′.

The two sequences differ by a short variable region (underlined), where the first has a sequence of TATTTAT and the second has a sequence of ACGTGCA. In the DAG, that locus is represented by a first node 101 with the sequence 5′-CCCAGAAC-3′; a second node 102 with the sequence 5′-CATCGTAGA-3′; a third node 103 with the sequence 5′-TATTTAT-3′; and a fourth node 104 with the sequence 5′-ACGTGCA-3′.

Nodes 101 and 102 represent the conserved regions between the two reference sequences. Nodes 103 and 104 represent the variable region between the reference sequences. In FIG. 3, even though both reference sequences have a thymine (T) as the fourth base in the variable region, the DAG does not have a node at that position because in accordance with the invention, the DAG only represents observed sequences. If a node were created at that position, with corresponding edges connecting that hypothetical node to the other nodes in the sequence, then an artificial path would be created. That artificial path would not correspond to any observed sequence, and would thus represent an artificial non-candidate sequence. The presence of such sequences in the DAG hampers alignment of new sequences to paths in the DAG because it inserts false positives into the analysis. That undesired scenario is shown in FIG. 4.

FIG. 4 shows loci 201 as it would be interpreted by a prior art DAG such as the SINA aligner. In FIG. 4B, the matching nucleotide is collapsed into a new node 129, which also results in additional nodes 121, 123, 125, and 127. Also new paths are created that do not correspond to observed nucleotide sequences. For example, the DAG of FIG. 4 includes a path comprising nodes 121, 129, and 127, which gives a sequence of TATTGCA for the variable region of locus 201. However, according to the example, TATTGCA has not been observed in any of the reference sequences. Therefore the path comprising nodes 121, 129, and 127 is an artificial sequence that could lead to a false positive alignment of a novel sequence read.

The present invention avoids creating artificial paths. The DAG differentiates between the observed sequences (TATTTAT and ACGTGCA) and those that do not occur in the references (TATTGCA or ACGTTAT). As shown in FIG. 3, the DAG of the invention only creates nodes and edges that correspond to observed sequences, thereby excluding artificial non-candidates from the analysis.

The invention provides methods and systems for aligning sequence reads to a DAG. Using alignment algorithms of the invention, reads can be rapidly mapped despite their large numbers. Numerous benefits obtain by using a DAG as a reference. For example, aligning against a DAG is more accurate than aligning against one reference and then attempting to adjust one's results in light of other extrinsic information. This is primarily because the latter approach enforces an unnatural asymmetry between the sequence used in the initial alignment and other information. Aligning against an object that potentially represents all the relevant physical possibilities is much more computationally efficient than attempting to align against a linear sequence for each physical possibility (the number of such possibilities will generally be exponential in the number of junctions).

Methods of the invention useful for identifying an unknown organism, or “typing a microbe”, include transforming known, linear reference sequences into a reference DAG composed of nodes connected by edges. Each known microorganism is represented by a path through the DAG wherein tracing that path provides the sequence of the conserved gene for that microorganism. The node and edge objects are stored in a tangible, non-transitory memory subsystem of a computer system, and the DAG is preferably created using adjacency such that a node or edge object is read by de-referencing a pointer and reading directly from an indicated physical location in the non-transitory memory subsystem (thus avoiding an index lookup or other search operation as would be required in relational databases or other linear, flat-file storage methods). Preferably, the plurality of known microorganisms includes at least 25,000 distinct microorganisms and the DAG contains paths representing the sequence of the conserved gene for each of the at least 25,000 organisms. The optimal-scoring alignment between the sequence reads and one of the paths within the DAG can be determined by comparing the sequence reads to each sequence of the conserved gene for each of the at least 25,000 organisms without performing a pairwise alignment between the sequence of the conserved gene and a linear copy of each sequence of the conserved gene for each of the at least 25,000 organisms.

Accordingly, the invention transforms reference sequences into a condensed format, which allows new sequences to be more easily and efficiently aligned, thereby facilitating microorganism identification. The invention uses linear reference sequences and transforms them into a DAG that represents conserved regions and the connections between them as nodes and edges. That transformed data is provided in a format that makes alignment of new sequences substantially easier.

Prior art alignment methods require much more computing power to align to as many references as are encompassed by the DAG of the invention. Prior art methods require exponentially more computing power to handle an exhaustive pairwise alignment to all known sequences. Those methods require many additional calculations and clock cycles to perform a comparable alignment as envisioned by the present disclosure. Systems and methods of the present invention, on the other hand, transform those numerous reference sequences into a usable DAG format, such that conserved portions of the numerous reference sequences are represented as single nodes. The invention performs a multidimensional backtrack alignment, which requires far fewer calculations and reduced computing resources. In particular, reads are essentially aligned against the conserved portions of the numerous reference sequences once, as opposed to multiple times (i.e., against each individual reference sequence). The invention therefore makes it possible for such large-scale sequence alignments to be done on an off-the-shelf computer.

The invention thus makes methods and systems of microorganism identification much more accessible and available in real-world situations, thereby providing a substantial improvement in the field of applied microbiology. The invention makes possible portable devices for quickly and accurately typing an unknown microorganism.

Embodiments of the invention include aligning one or more reads to a path in the DAG.

Pairwise alignment generally involves placing one sequence along part of target, introducing gaps according to an algorithm, scoring how well the two sequences match, and preferably repeating for various positions along the reference. The best-scoring match is deemed to be the alignment and represents an inference about what the sequence data represents. In some embodiments, scoring an alignment of a pair of nucleic acid sequences involves setting values for the probabilities of substitutions and indels. When individual bases are aligned, a match or mismatch contributes to the alignment score by a substitution probability, which could be, for example, 1 for a match and −0.33 for a mismatch. An indel deducts from an alignment score by a gap penalty, which could be, for example, −1. Gap penalties and substitution probabilities can be based on empirical knowledge or a priori assumptions about how sequences evolve. Their values affect the resulting alignment. Particularly, the relationship between the gap penalties and substitution probabilities influences whether substitutions or indels will be favored in the resulting alignment.

Stated formally, an alignment represents an inferred relationship between two sequences, x and y. For example, in some embodiments, an alignment A of sequences x and y maps x and y respectively to another two strings x′ and y′ that may contain spaces such that: (i) |x′|=|y′|; (ii) removing spaces from x′ and y′ should get back x and y, respectively; and (iii) for any i, x′[i] and y′[i] cannot be both spaces.

A gap is a maximal substring of contiguous spaces in either x′ or y′. An alignment A can include the following three kinds of regions: (i) matched pair (e.g., x′[i]=y′[i]; (ii) mismatched pair, (e.g., x′[i]≠y[i] and both are not spaces); or (iii) gap (e.g., either x′[i . . . j] or y′[i . . . j] is a gap). In certain embodiments, only a matched pair has a high positive score a. In some embodiments, a mismatched pair generally has a negative score b and a gap of length r also has a negative score g+rs where g, s<0. For DNA, one common scoring scheme (e.g. used by BLAST) makes score a=1, score b=−3, g=−5 and s=−2. The score of the alignment A is the sum of the scores for all matched pairs, mismatched pairs and gaps. The alignment score of x and y can be defined as the maximum score among all possible alignments of x and y.

In some embodiments, any pair has a score a defined by a 4×4 matrix B of substitution probabilities. For example, B(i,i)=1 and 0<B(i,j)_{i< >j}<1 is one possible scoring system. For instance, where a transition is thought to be more biologically probable than a transversion, matrix B could include B(C,T)=0.7 and B(A,T)=0.3, or any other set of values desired or determined by methods known in the art.

Alignment according to some embodiments of the invention includes pairwise alignment. A pairwise alignment, generally, involves—for sequence Q (query) having m characters and a reference genome T (target) of n characters—finding and evaluating possible local alignments between Q and T. For any 1≦i≦n and 1≦j≦m, the largest possible alignment score of T[h . . . i] and Q[k . . . j], where h≦i and k≦j, is computed (i.e. the best alignment score of any substring of T ending at position i and any substring of Q ending at position j). This can include examining all substrings with cm characters, where c is a constant depending on a similarity model, and aligning each substring separately with Q. Each alignment is scored, and the alignment with the preferred score is accepted as the alignment. One of skill in the art will appreciate that there are exact and approximate algorithms for sequence alignment. Exact algorithms will find the highest scoring alignment, but can be computationally expensive. Two well-known exact algorithms are Needleman-Wunsch (J Mol Biol, 48(3):443-453, 1970) and Smith-Waterman (J Mol Biol, 147(1):195-197, 1981; Adv. in Math. 20(3), 367-387, 1976). A further improvement to Smith-Waterman by Gotoh (J Mol Biol, 162(3), 705-708, 1982) reduces the calculation time from O(m²n) to O(mn) where m and n are the sequence sizes being compared and is more amendable to parallel processing. In the field of bioinformatics, it is Gotoh's modified algorithm that is often referred to as the Smith-Waterman algorithm. Smith-Waterman approaches are being used to align larger sequence sets against larger reference sequences as parallel computing resources become more widely and cheaply available. See, e.g., Amazon's cloud computing resources. All of the journal articles referenced herein are incorporated by reference in their entireties.

The Smith-Waterman (SW) algorithm aligns linear sequences by rewarding overlap between bases in the sequences, and penalizing gaps between the sequences. Smith-Waterman also differs from Needleman-Wunsch, in that SW does not require the shorter sequence to span the string of letters describing the longer sequence. That is, SW does not assume that one sequence is a read of the entirety of the other sequence. Furthermore, because SW is not obligated to find an alignment that stretches across the entire length of the strings, a local alignment can begin and end anywhere within the two sequences.

In some embodiments, pairwise alignment proceeds according to dot-matrix methods, dynamic programming methods, or word methods. Dynamic programming methods generally implement the Smith-Waterman (SW) algorithm or the Needleman-Wunsch (NW) algorithm. Alignment according to the NW algorithm generally scores aligned characters according to a similarity matrix S(a,b) (e.g., such as the aforementioned matrix B) with a linear gap penalty d. Matrix S(a,b) generally supplies substitution probabilities. The SW algorithm is similar to the NW algorithm, but any negative scoring matrix cells are set to zero. The SW and NW algorithms, and implementations thereof, are described in more detail in U.S. Pat. No. 5,701,256 and U.S. Pub. 2009/0119313, both herein incorporated by reference in their entirety.

As discussed above, it may be preferable or desirable to implement the SW alignment algorithm or a modified version of (discussed in greater detail below) when aligning sequences to a direct acyclic annotated reference sequence.

The SW algorithm is easily expressed for an n×m matrix H, representing the two strings of length n and m, in terms of equation (1) below:

Hₖ₀=H₀₁=0 (for 0≦k≦n and 0≦1≦m)

Hᵢⱼ=max{H_{i-1,j-1}+s(aᵢ,bⱼ),H_{i-1,j}−Wᵢₙ,H_{i,j-1}−W_{del},0}(for 1≦i≦n and 1≦j≦m) (1)

In the equations above, s(aᵢ,bⱼ) represents either a match bonus (when aᵢ=bⱼ) or a mismatch penalty (when aᵢ≠bⱼ), and insertions and deletions are given the penalties Wₘ and W_{del}, respectively. In most instances, the resulting matrix has many elements that are zero. This representation makes it easier to backtrack from high-to-low, right-to-left in the matrix, thus identifying the alignment.

Once the matrix has been fully populated with scores, the SW algorithm performs a backtrack to determine the alignment. Starting with the maximum value in the matrix, the algorithm will backtrack based on which of the three values (Hᵢ₋ⱼ₋₁, H_{i-1,j}, or H_{i,j-1}) was used to compute the final maximum value for each cell. The backtracking stops when a zero is reached. The optimal-scoring alignment may contain greater than the minimum possible number of insertions and deletions, while containing far fewer than the maximum possible number of substitutions.

When applied as SW or SW-Gotoh, the techniques use a dynamic programming algorithm to perform local sequence alignment of the two strings, S and A, of sizes m and n, respectively. This dynamic programming technique employs tables or matrices to preserve match scores and avoid re-computation for successive cells. Each element of the string can be indexed with respect to a letter of the sequence, that is, if S is the string ATCGAA, S[1]=A.

Instead of representing the optimum alignment as H_{i,j} (above), the optimum alignment can be represented as B[j,k] in equation (2) below:

B[j,k]=max(p[j,k],i[j,k],d[j,k],0)(for 0<j≦m,0<k≦n) (2)

The arguments of the maximum function, B[j,k], are outlined in equations (3)-(5) below, wherein MISMATCH_PEN, MATCH_BONUS, INSERTION_PEN, DELETION_PEN, and OPENING_PEN are all constants, and all negative except for MATCH_BONUS (PEN is short for PENALTY). The match argument, p[j,k], is given by equation (3), below:

$$\begin{matrix}p [ j , k ] = max ( p [ j - 1 , k - 1 ] , i [ j - 1 , k - 1 ] , d [ j - 1 , k - 1 ] ) + \\ MISMATCH\_PEN , if S [ j ] \neq A [ k ] \\ = max ( p [ j - 1 , k - 1 ] , i [ j - 1 , k - 1 ] , d [ j - 1 , k - 1 ] ) + \\ MISMATCH\_BONUS , if S [ j ] = A [ k ]\end{matrix} \qquad ( 3 )$$

the insertion argument i[j,k], is given by equation (4), below:

i[j,k]=max(p[j−1,k]+OPENING_PEN,i[j−1,k],d[j−1,k]+OPENING_PEN)+INSERTION_PEN (4)

and the deletion argument d[j,k], is given by equation (5), below:

d[j,k]=max(p[j,k−1]+OPENING_PEN,i[j,k−1]+OPENING_PEN,d[j,k−1])+DELETION_PEN (5)

For all three arguments, the [0,0] element is set to zero to assure that the backtrack goes to completion, i.e., p[0,0]=i[0,0]=d[0,0]=0.

The scoring parameters are somewhat arbitrary, and can be adjusted to achieve the behavior of the computations. One example of the scoring parameter settings (Huang, Chapter 3: Bio-Sequence Comparison and Alignment, ser. Curr Top Comp Mol Biol. Cambridge, Mass.: The MIT Press, 2002) for nucleic acids would be:

MATCH_BONUS: 10

MISMATCH_PEN: −20

INSERTION_PEN: −40

OPENING_PEN: −10

DELETION_PEN: −5

The relationship between the gap penalties (INSERTION_PEN, OPENING_PEN) above help limit the number of gap openings, i.e., favor grouping gaps together, by setting the gap insertion penalty higher than the gap opening cost. Of course, alternative relationships between MISMATCH_PEN, MATCH_BONUS, INSERTION_PEN, OPENING_PEN and DELETION_PEN are possible.

In some embodiments, the methods and systems of the invention incorporate multi-dimensional alignment algorithms. Multi-dimensional algorithms of the invention provide for a “look-back” type analysis of sequence information (as in Smith-Waterman), wherein the look back is conducted through a multi-dimensional space that includes multiple pathways and multiple nodes. The multi-dimensional algorithm can be used to align sequence reads against the DAG-type reference. That alignment algorithm identifies the maximum value for C_{i,j} by identifying the maximum score with respect to each sequence contained at a position on the DAG (e.g., the reference sequence construct). In fact, by looking “backwards” at the preceding positions, it is possible to identify the optimum alignment across a plurality of possible paths.

The modified Smith-Waterman alignment described here, also known as the multi-dimensional alignment, provides exceptional speed when performed in a DAG system that employs physical memory addressing (e.g., through the use of native pointers or index free adjacency as discussed above). The invention combines multi-dimensional alignment functionality with the use of spatial memory addresses (e.g., native pointers or index-free adjacency) to retrieve data from objects in the reference DAG, and thereby facilitates alignment against a conserved region from thousands or even millions of species.

The algorithm of the invention is carried out on a read (a.k.a. “string”) and a graph, such as a directed acyclic graph (DAG), discussed above. For the purpose of defining the algorithm, let S be the string being aligned, and let D be the directed acyclic graph to which S is being aligned. The elements of the string, S, are bracketed with indices beginning at 1. Thus, if S is the string ATCGAA, then S[1]=A; S[4]=G; etc.

In certain embodiments, for the DAG, each letter of the sequence of a node will be represented as a separate element, d. A predecessor of d is defined as:

(i) If d is not the first letter of the sequence of its node, the letter preceding d in its node is its (only) predecessor;

(ii) If d is the first letter of the sequence of its node, the last letter of the sequence of any node (e.g., all residues upstream in the 16S rRNA gene) that is a parent of d's node is a predecessor of d.

The set of all predecessors is, in turn, represented as P[d].

In order to find the “best” alignment, the algorithm seeks the value of M[j,d], the score of the optimal alignment of the first j elements of S with the portion of the DAG preceding (and including) d. This step is similar to finding H_{i,j} in equation 1 above. Specifically, determining M[j,d] involves finding the maximum of a, i, e, and 0, as defined below:

M[j,d]={a,i,e,0} (6)

where

e=max{M[j,p*]+DELETE_PEN} for p* in P[d]

i=M[j−1, d]+INSERT_PEN

a=max{M[j−1, p*]+MATCH_SCORE} for p* in P[d], if S[j]=d;

max{M[j−1, p*]+MISMATCH_PEN} for p* in P[d], if S[j]≠M

As described above, e is the highest of the alignments of the first j characters of S with the portions of the DAG up to, but not including, d, plus an additional DELETE_PEN. Accordingly, if d is not the first letter of the sequence of the node, then there is only one predecessor, p, and the alignment score of the first j characters of S with the DAG (up-to-and-including p) is equivalent to M[j,p]+DELETE_PEN. In the instance where d is the first letter of the sequence of its node, there can be multiple possible predecessors, and because the DELETE_PEN is constant, maximizing [M[j,p*]+DELETE_PEN] is the same as choosing the predecessor with the highest alignment score with the first j characters of S.

In equation (6), i is the alignment of the first j−1 characters of the string S with the DAG up-to-and-including d, plus an INSERT_PEN, which is similar to the definition of the insertion argument in SW (see equation 1).

Additionally, a is the highest of the alignments of the first j characters of S with the portions of the DAG up to, but not including d, plus either a MATCH_SCORE (if the jth character of S is the same as the character d) or a MISMATCH_PEN (if the jth character of S is not the same as the character d). As with e, this means that if d is not the first letter of the sequence of its node, then there is only one predecessor, i.e., p. That means a is the alignment score of the first j−1 characters of S with the DAG (up-to-and-including p), i.e., M[j−1,p], with either a MISMATCH_PEN or MATCH_SCORE added, depending upon whether d and the jth character of S match. In the instance where d is the first letter of the sequence of its node, there can be multiple possible predecessors. In this case, maximizing {M[j,p*]+MISMATCH_PEN or MATCH_SCORE} is the same as choosing the predecessor with the highest alignment score with the first j−1 characters of S (i.e., the highest of the candidate M[j−1,p*] arguments) and adding either a MISMATCH_PEN or a MATCH_SCORE depending on whether d and the jth character of S match.

Again, as in the SW algorithm, the penalties, e.g., DELETE_PEN, INSERT_PEN, MATCH_SCORE and MISMATCH_PEN, can be adjusted to encourage alignment with fewer gaps, etc.

As described in the equations above, the algorithm finds the optimal (i.e., maximum) value for each read by calculating not only the insertion, deletion, and match scores for that element, but looking backward (against the direction of the DAG) to any prior nodes on the DAG to find a maximum score. Thus, the algorithm is able to traverse the different paths through the DAG, which contain the known mutations. Because the graphs are directed, the backtracks, which move against the direction of the graph, follow the preferred isoform toward the origin of the graph, and the optimal alignment score identifies the most likely alignment within a high degree of certainty.

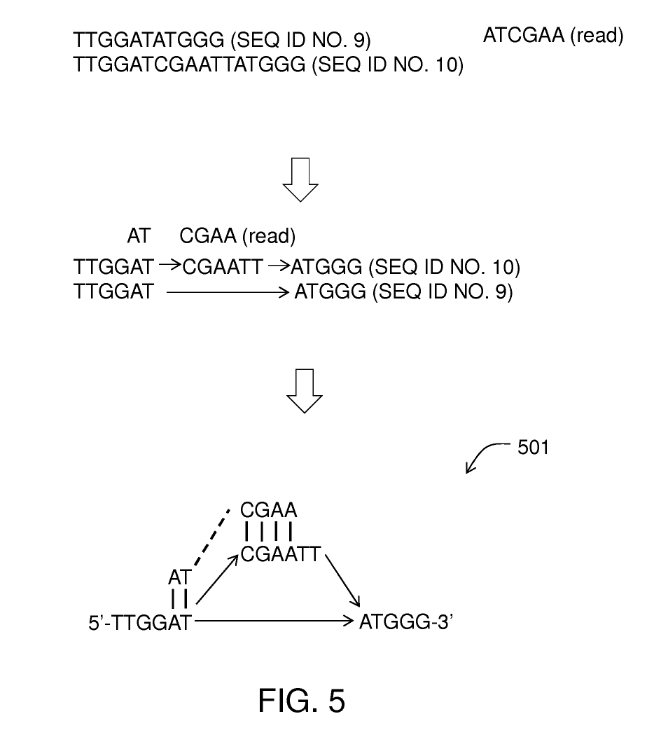

FIG. 5 describes mapping a sequence read to a DAG 501 and aids in illustrating aligning a sequence to a DAG. In the top portion of FIG. 5, a hypothetical sequence read “ATCGAA” is presented along with the following two hypothetical sequences:

(SEQ ID NO. 9)
TTGGATATGGG
(SEQ ID NO. 10)
TTGGATCGAATTATGGG

The middle portion of FIG. 5 is drawn to illustrate that SEQ ID NOS. 9 and 10 relate by a six character indel, where it is assumed that there is a prior knowledge that the hypothetical read aligns to SEQ ID NO. 10, extending into the indel. In the middle portion of FIG. 5, the depiction is linearized and simplified to aid in visualization.

The bottom portion of FIG. 5 illustrates creation of a DAG 501 to which the hypothetical sequence read is aligned. In the depicted DAG 501, SEQ ID NOS. 9 and 10 can both be read by reading from the 5′ end of DAG 501 to the 3′ end of the DAG, albeit along different paths. The sequence read is shown as aligning to the upper path as depicted.

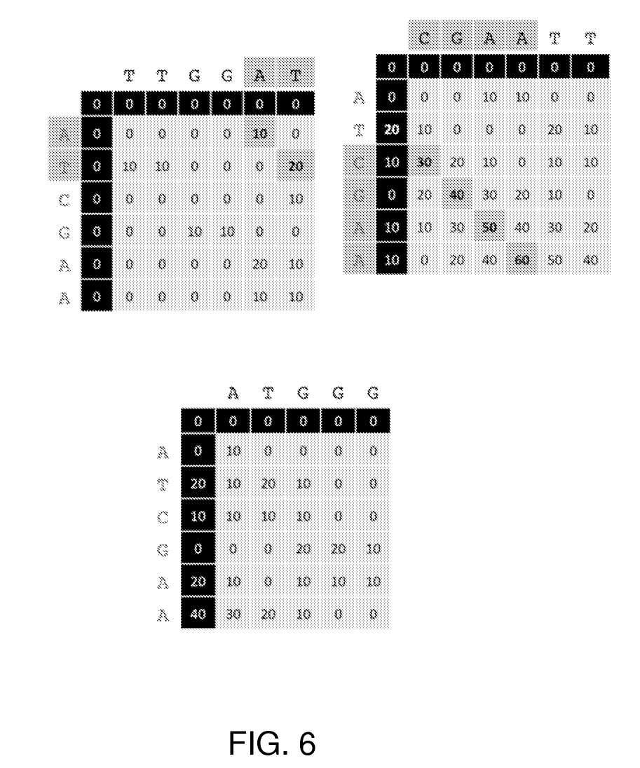

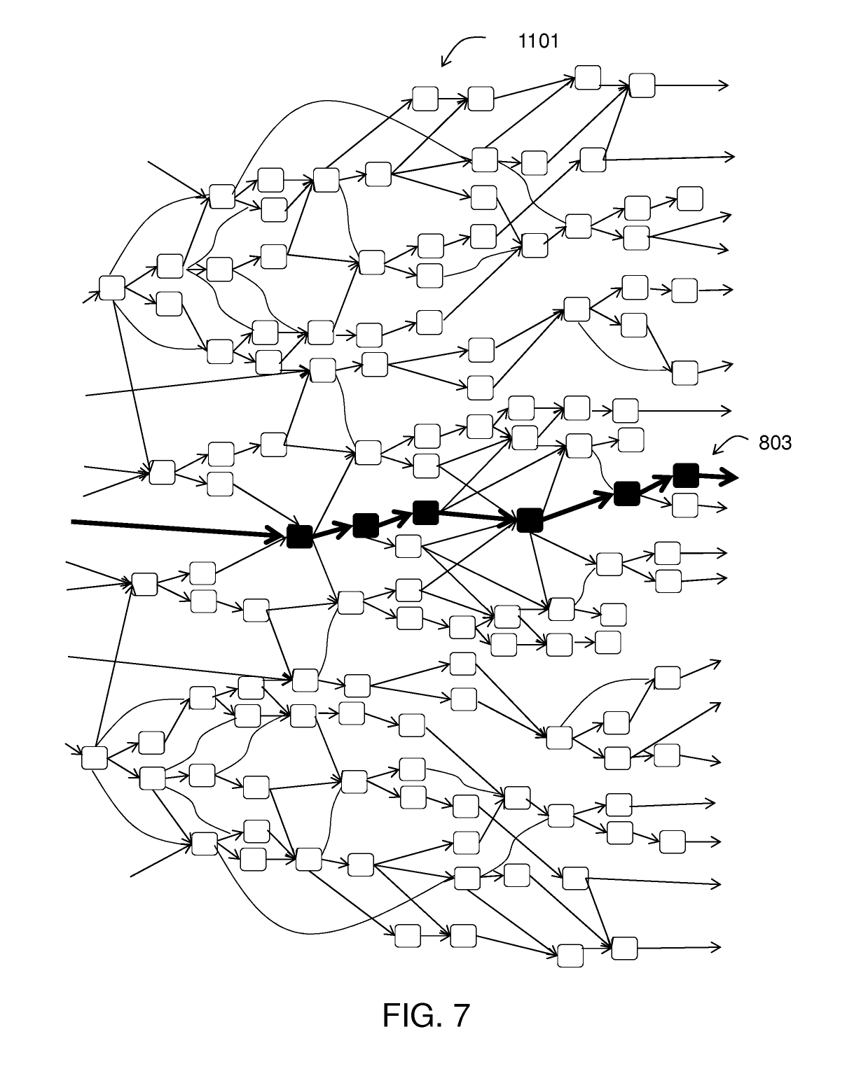

FIG. 6 shows the actual matrices that correspond to the comparison. Like the Smith-Waterman technique, the illustrated algorithm of the invention identifies the highest score and performs a backtrack to identify the proper location of the read. FIGS. 4 and 5 also highlight that the invention produces an actual match for the string against the construct. In the instances where the sequence reads include variants that were not included in the DAG, the aligned sequence will be reported out with a gap, insertion, etc.

In some embodiments, the DAG includes sequences from at least 25,000 distinct microorganisms, each of which is represented by at least one path through the DAG, and each path representing an observed sequence of a conserved gene such as 16S rRNA. In determining the optimal-scoring alignment between sample sequence reads and one of the paths within the DAG, the sequence reads are compared to each path in the DAG. The DAG representing paths for thousands or millions of species may thus be quite large. By compressing the data into a DAG, the computational challenge of comparing the sequence reads to all of those possible species is reduced. In an exhaustive alignment, a sequence read is aligned to all possible references. The invention allows that alignment process to be streamlined by aligning to paths within the DAG and determining the path of best fit.

In order to identify a microorganism in the sample, systems and methods of the invention align sample sequences to a path in the DAG and produce a corresponding report. The report identifies one or more microorganisms based on the paths to which the reads aligned. To produce such a report, the invention references information stored in the DAG that relates a path in the DAG to a corresponding microorganism. A microorganism having multiple copies of the conserved gene represented in the DAG may have more than one corresponding path. Nevertheless, the invention can identify each path associated with a known microorganism. Because the DAG compresses sequence data into nodes, an individual node or a series of node and edges giving less than the full conserved gene may correspond to multiple organisms. In some cases, the full gene may be identical between two species. The report generated by the invention indicates a microorganism that corresponds to the aligned sample sequences. It may further indicate alignment scores, which show how well the sequences correlate to the identified species. The report may list several microorganisms when more than one microorganism is present in the sample, or when the reads aligned to more than one path. The report may also list the most likely organism, or a more generic description of each organism (e.g., according to species, genus, and family), which can be helpful if aligned paths are ambiguous with respect to a particular organism, or if a more general report is desired. The invention may produce a report that comprises a data file readable by a computer. The report may be displayed on a monitor or printed. The report may depict the matching microorganism(s) in a list or a table, with corresponding alignment percentages or scores. The report may comprise a graphical depiction of the alignment or a graphical depiction of the identified microorganisms and their respective scores.

FIG. 7 shows a small part of a hypothetical DAG. The boxes represent nodes and the arrows between the boxes represent edges. Each path formed by the combination of nodes and edges makes up a path, and each path is associated with a microorganism. In the example shown, sequence reads from an unknown sample have aligned to a particular path 803 in the DAG. To aid in visualization, the path 803 is shown with thicker edges and blackened nodes. In this case, the path 803 is the only path to which the sequence reads aligned above some threshold alignment percentage. In order to identify the microorganism, the selected path 803 is compared to a table or graph stored within the DAG that correlates the paths to particular microorganisms.

The identities of microorganisms can be stored the memory device of the computer. A memory device is a mechanical device that stores data or instructions in a machine-readable format. The invention stores sequence data in a graph format, allowing for fast retrieval of data from the memory by using index-free adjacency and adjacency lists to obviate the need for index lookups. Pointers reference a particular physical location in the memory, making to fast access to storage. Memory may include one or more sets of instructions (e.g., software) which, when executed by one or more of the processors of the disclosed computers can accomplish some or all of the methods or functions described herein. The memory may be a non-transitory memory device such as a solid state drive, flash drive, disk drive, hard drive, subscriber identity module (SIM) card, secure digital card (SD card), micro SD card, or solid-state drive (SSD), optical and magnetic media, others, or a combination thereof, and the objects stored in the memory can be assigned specific physical locations in the memory for fast lookup.

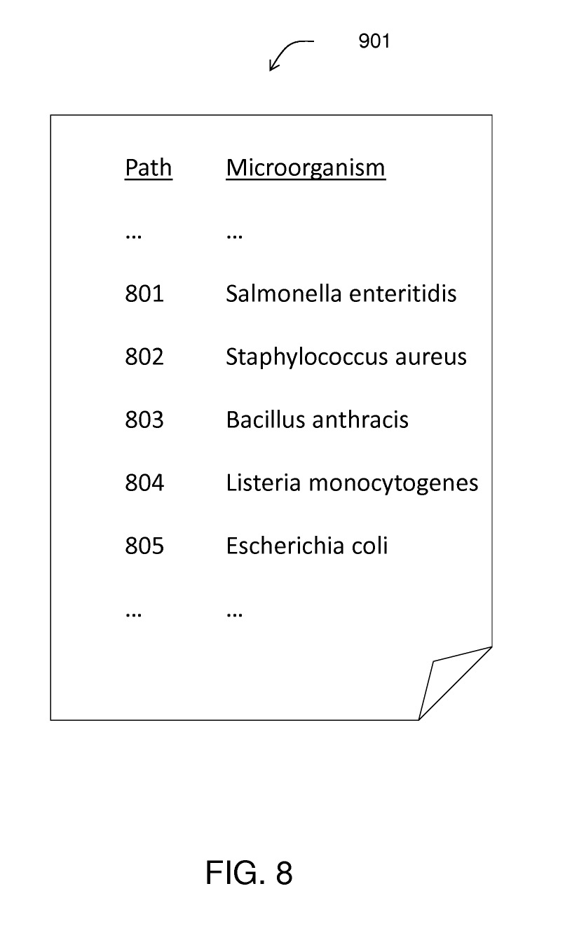

The memory may include a table of microorganisms matched with their corresponding paths in the DAG. FIG. 8 shows an example of a part of such a table 901. Based on the path 803 identified in the alignment of FIG. 7, the computer processor could retrieve the identity of the microorganism associated with the path and identify the sample. In the example shown, the path 803 corresponds to Bacillus anthracis. The computer may retrieve the identities (or multiple identities) based on the alignment and produce a report identifying one or more microorganisms. Based on the alignment, the report indicates the microorganism that has the closest alignment, and it may also report the percentages of reads aligned. The report can conclude that more than one microorganism is present, and for example, include any microorganism corresponding to a path within the DAG having greater than 90% alignment. The alignment threshold can be adjusted according to the needs of the user.

The report may rank the identified microorganisms based on their percentage of reads aligned or percentage of nucleotides matched. It may also rank them according to the difference between the identified microorganism and the next-best alignment for a particular sequence read.

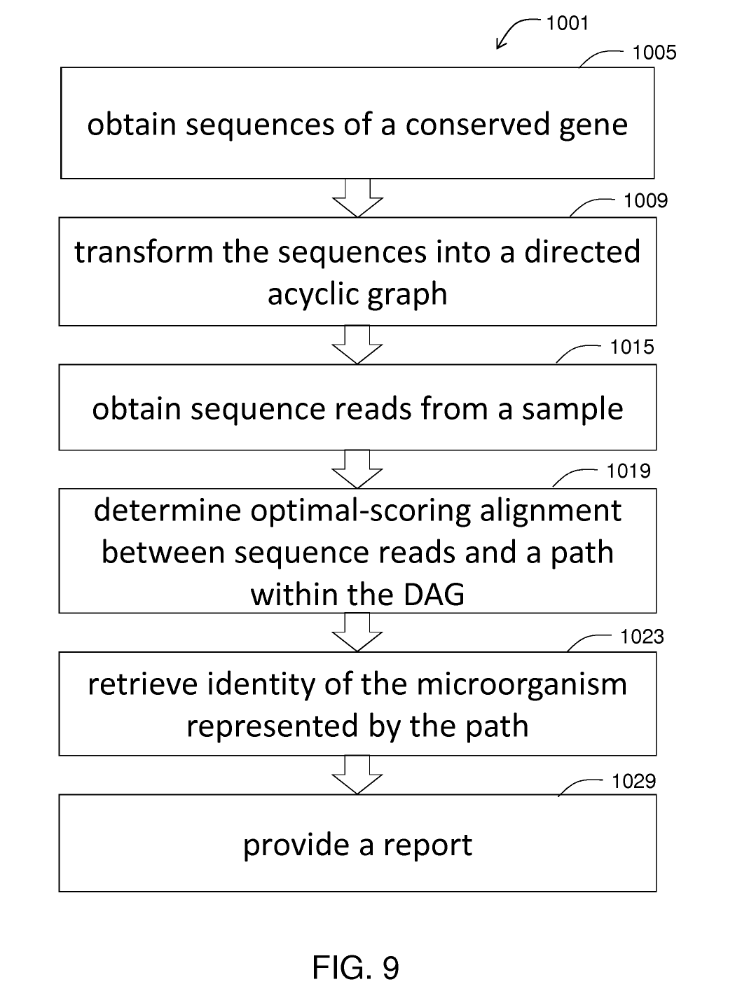

FIG. 9 shows a diagram of a method 1001 according to certain embodiments of the invention. In general, the invention provides a method 1001 for identifying a microorganism, wherein a computer system is used to build a DAG containing conserved genetic information for microorganisms, then compare sequence reads from a microorganism sample to the DAG, and ultimately provide a report identifying a microorganism in the sample. The method 1001 includes obtaining 1005 a sequence of a conserved gene for each of a plurality of microorganisms. The gene may be 16S rRNA, or any other conserved gene known in the art to be useful for phylogenetic studies. The sequences can be obtained from a variety of available online databases, or they could be input manually. The sequences can also include novel sequences incorporated into the DAG by aligning new samples to the DAG. The sequences are then transformed 1009 into a DAG. The DAG includes sequence data compressed into nodes and edges representing observed sequences and the connections between them. Each microorganism represented in the DAG corresponds to at least one path through the DAG, which contains the sequence of the conserved gene for that microorganism. The method 1001 further includes obtaining 1015 sequence reads from a sample containing nucleic acid from a microorganism. The nucleic acid can be obtained by culturing a microorganism in a dish, then extracting nucleic acid using known methods. Alternatively, the sample could be an unidentified organic sample collected in the field or a water sample collected from the ocean. Sequence reads can be obtained from the sample using any of the sequencing methods described herein. The sequence reads from the sample are aligned to the DAG reference using an alignment algorithm. An optimal-scoring alignment is determined 1019 between the sequence reads and a path within the DAG. Based on the optical-scoring alignment, the identity of a microorganism or microorganisms represented by the path or portions thereof is retrieved 1023. The DAG contains identities of microorganisms corresponding to each path.

A report is provided 1029 that includes the identity of the microorganism. The report can include a list of microorganisms that correspond to multiple paths to which sequence reads aligned, which may indicate the presence of multiple species in the sample. The report may also include scores and percentages of reads aligned or nucleotides matched to each path. The report may provide probabilities of microorganism identities based on how closely the sequence reads aligned to a particular path versus the next-best alignment. The report may also include various summary statistics about the sample, including proportions of sequence reads and/or identified microorganisms within the sample, a taxonomic classification of microorganisms, and the like.

Any development environment, database, or language known in the art may be used to implement embodiments of the invention. Exemplary languages, systems, and development environments include Perl, C++, Python, Ruby on Rails, JAVA, Groovy, Grails, Visual Basic .NET. An overview of resources useful in the invention is presented in Barnes (Ed.), Bioinformatics for Geneticists: A Bioinformatics Primer for the Analysis of Genetic Data, Wiley, Chichester, West Sussex, England (2007) and Dudley and Butte, A quick guide for developing effective bioinformatics programming skills, PLoS Comput Biol 5(12):e1000589 (2009).

In some embodiments, methods are implemented by a computer application developed in Perl (e.g., optionally using BioPerl). See Tisdall, Mastering Perl for Bioinformatics, O'Reilly & Associates, Inc., Sebastopol, C A 2003. In some embodiments, applications are developed using BioPerl, a collection of Perl modules that allows for object-oriented development of bioinformatics applications. BioPerl is available for download from the website of the Comprehensive Perl Archive Network (CPAN). See also Dwyer, Genomic Perl, Cambridge University Press (2003) and Zak, CGI/Perl, 1st Edition, Thomson Learning (2002).

In certain embodiments, applications are developed using Java and optionally the BioJava collection of objects, developed at EBI/Sanger in 1998 by Matthew Pocock and Thomas Down. BioJava provides an application programming interface (API) and is discussed in Holland, et al., BioJava: an open-source framework for bioinformatics, Bioinformatics 24(18):2096-2097 (2008). Programming in Java is discussed in Liang, Introduction to Java Programming, Comprehensive (8th Edition), Prentice Hall, Upper Saddle River, N.J. (2011) and in Poo, et al., Object-Oriented Programming and Java, Springer Singapore, Singapore, 322 p. (2008).

Applications can be developed using the Ruby programming language and optionally BioRuby, Ruby on Rails, or a combination thereof. Ruby or BioRuby can be implemented in Linux, Mac OS X, and Windows as well as, with JRuby, on the Java Virtual Machine, and supports object oriented development. See Metz, Practical Object-Oriented Design in Ruby: An Agile Primer, Addison-Wesley (2012) and Goto, et al., BioRuby: bioinformatics software for the Ruby programming language, Bioinformatics 26(20):2617-2619 (2010).

It is worth noting that the sequences need not pre-exist within the DAG. In fact, a DAG comprising the 16S rRNA genes of many or all known microbes is particularly useful for discovering an as-yet novel or uncharacterized microorganism, as all of the surrounding genetic information will map to a path with an excellent score and the alignment algorithm will reveal the need to create a new node to represent the new sequence as it is being discovered by doing the alignment. Accommodating the newly discovered sequence is easy as the DAG simply then includes it by virtue of having been used in the alignment. That is, in some embodiments, the distinction between extrinsic reference 16S rRNA data and a microbe of interest's 16S rRNA sequences is a vanishing distinction and every instance of analyzing NGS reads to genotype a new microbe is also an instance of developing the reference.

In certain embodiments, a graph according to the disclosure may also be populated with data sufficient to classify organisms and bacteria at a broader level, e.g., by genus, family, order, and the like. In these embodiments, certain representative sequences may be used to populate the graph, each associated with a particular classification. This results in a graph having a smaller footprint (i.e., fewer nodes and edges), which may be used to quickly type a population of bacteria at a more general level. However, in these embodiments, proper alignment relies on allowing a certain number of mismatches between sequence reads and conserved segments of the graph, and thus some reads may not align as well as they would to a fully populated graph (e.g., according to other embodiments described above).

Further, while the present disclosure refers to systems and methods of using a DAG to perform alignments of sequencing data, any form of graph may be used, including those that lack direction or include cycles (i.e., are not acyclic). Various kinds of graphs may be used according to embodiments of the disclosure.

Methods described herein can be performed using a system that includes hardware as well as software and optionally firmware.

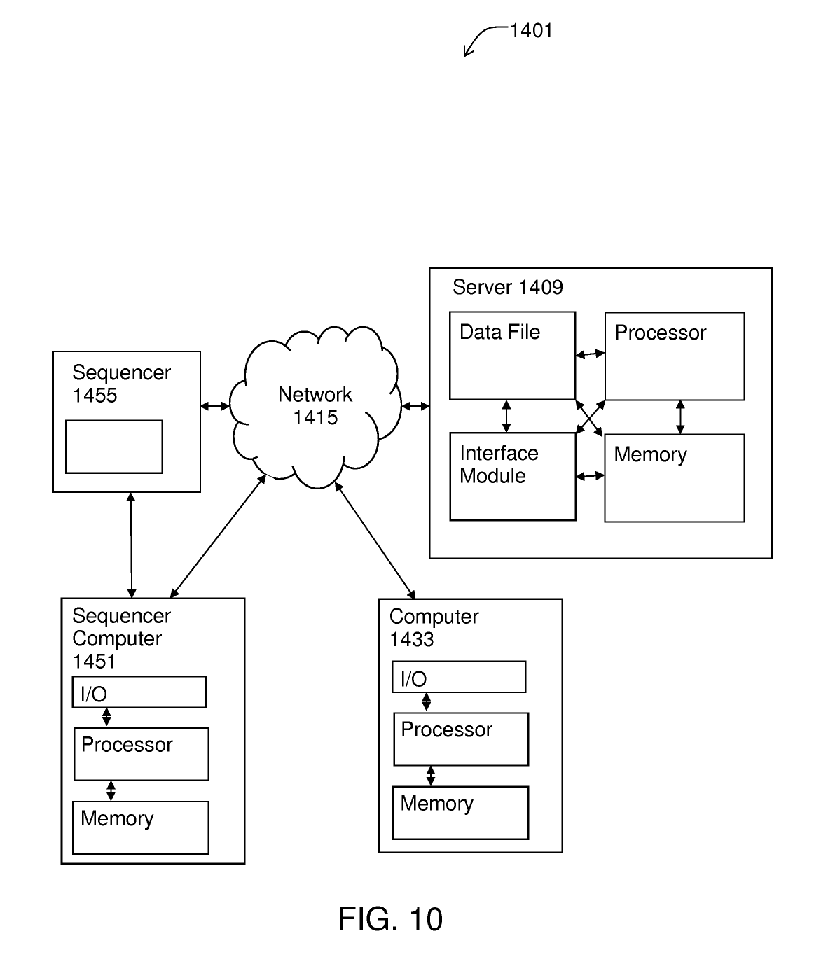

FIG. 10 illustrates a system 1401 useful for performing methods described herein. Sequence may be obtained, directly or indirectly, as reads from a sequencer 1455, either direct from the instrument or via a computer 1451 used for preliminary collection and any processing of sequence reads. Network 1415 relays data and information among the different computers. Steps of methods described herein may be performed by a server computer 1409 or by a personal computing device 1433 (e.g., a laptop, desktop, tablet, etc.) Computing device 1433 can be used to interact with server 1409 to initiate method steps or obtain results. In generally, a computer includes a processor coupled to memory and at least one input/output device.

A processor may be any suitable processor such as the microprocessor sold under the trademark XEON E7 by Intel (Santa Clara, Calif.) or the microprocessor sold under the trademark OPTERON 6200 by AMD (Sunnyvale, Calif.).

Memory generally includes a tangible, non-transitory computer-readable storage device and can include any machine-readable medium or media on or in which is stored instructions (one or more software applications), data, or both. The instructions, when executed, can implement any or all of the functionality described herein. The term “computer-readable storage device” shall be taken to include, without limit, one or more disk drives, tape drives, flash drives, solid stated drives (SSD), memory devices (such as RAM, ROM, EPROM, etc.), optical storage devices, and/or any other non-transitory and tangible storage medium or media.

Input/output devices according to the invention may include a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method for identifying a microorganism, comprising:
obtaining a sequence of a conserved gene for each of a plurality of microorganisms;
transforming, by a computer system comprising a processor coupled to a memory device, the sequences into a graph data structure comprising nodes connected by edges, wherein each microorganism is represented by a path through the graph data structure that contains the sequence of the conserved gene for that microorganism;
obtaining sequence reads from a sample containing nucleic acid from at least one microorganism;
determining optimal-scoring alignments between the sequence reads and one or more paths within the graph data structure; and
identifying one or more identities of one or more microorganisms represented by the one or more paths.

2. The method of claim 1, wherein the graph data structure comprises a directed acyclic graph (DAG).

3. The method of claim 1, further comprising providing a report that includes the identities of the one or more microorganisms.

4. The method of claim 1, wherein the identities of the one or more microorganisms includes one selected from the group consisting of species, genus, family, and order.

5. The method of claim 1, wherein obtaining the sequence reads comprises sequencing the nucleic acid.

6. The method of claim 2, wherein transforming the sequences into the DAG comprises creating the nodes using index-free adjacency wherein each node includes one pointer for each connected node to which that node is connected by an edge.

7. The method of claim 6, wherein each pointer identifies a location of the connected node.

8. The method of claim 7, wherein identifying the location of a connected node by a pointer includes identifying a physical location in the memory device where the connected node is stored.

9. The method of claim 1, wherein each of the nodes includes an adjacency list that stores a list of edges to which that node is adjacent.

10. The method of claim 9, wherein each adjacency list comprises pointers to specific physical locations within the memory of the adjacent edges.

11. The method of claim 1, wherein the graph data structure uses pointers to identify a physical location in the memory device where each node is stored.

12. The method of claim 1, wherein the conserved gene is a 16S rRNA gene.

13. The method of claim 1, wherein obtaining the sequence of the conserved gene for each of the plurality of microorganisms includes retrieving sequence data from an online database.

14. The method of claim 1, wherein the report includes identities and alignment scores of all microorganisms that meet an alignment score threshold.

15. The method of claim 1, wherein the plurality of microorganisms includes at least 25,000 distinct microorganisms and the graph data structure contains paths representing the sequence of the conserved gene for each of the at least 25,000 microorganisms.

16. The method of claim 15, wherein determining the optimal-scoring alignment between the sequence reads and one of the paths within the DAG includes comparing the sequence reads to each sequence of the conserved gene for each of the at least 25,000 microorganisms without performing a pairwise alignment between the sequence of the conserved gene and a linear copy of each sequence of the conserved gene for each of the at least 25,000 microorganisms.

17. The method of claim 1, wherein determining the optimal-scoring alignment includes:
calculating match scores between bases of the sequence reads and bases in the paths; and
looking backwards to predecessor bases in the candidate paths to identify a backtrack through the paths that gives an optimal score;
wherein the backtrack that gives the optimal score corresponds to the optimally-scoring alignment of the sequence reads to the paths.

18. A system for identifying a plurality of microorganisms in a sample, the system comprising a processor coupled to a memory subsystem comprising instructions that when executed by the processor cause the system to:
obtain a sequence of a conserved gene for each of a plurality of microorganisms;
transform the sequences into a graph data structure comprising nodes connected by edges, wherein each microorganism is represented by a path through the graph data structure that contains the sequence of the conserved gene for that microorganism;
determine optimal-scoring alignments between the sequence reads and one or more paths within the graph data structure;
identify one or more identities of the one or more microorganisms represented by the one or more paths; and
provide a report that includes the identities of the one or more microorganisms.

19. The method of claim 18, wherein the report provides a taxonomic classification of the microorganisms identified in the sample.

20. The method of claim 18, wherein determining the optimal-scoring alignment between the sequence reads and one of the paths within the DAG comprises comparing the sequence reads to each sequence of the conserved gene for each of the plurality of microorganisms without performing a pairwise alignment between the sequence of the conserved gene and a linear copy of each sequence of the conserved gene for each of the plurality of microorganisms.


SEQUENCE LISTING (10 sequences)

SEQ ID NO: 1 - DNA, 32 bp, Bacillus anthracis
cccagaacgttgcatcgtagacgagtttcagc

SEQ ID NO: 2 - DNA, 47 bp, Bacillus anthracis
cccagaacgttgctatgcaacaagggacatcgtagacgagtttcagc

SEQ ID NO: 3 - DNA, 47 bp, Bacillus anthracis
cccagaacgttgctatgcaggaagggacatcgtagacgagtttcagc

SEQ ID NO: 4 - DNA, 23 bp, Bacillus anthracis
ttgctatgcaggaagggacatcg

SEQ ID NO: 5 - DNA, 12 bp, Bacillus anthracis
cccagaacgttg

SEQ ID NO: 6 - DNA, 23 bp, Bacillus anthracis
catcgtagacgagtttcagcatt

SEQ ID NO: 7 - DNA, 24 bp, Bacillus anthracis
cccagaactatttatcatcgtaga

SEQ ID NO: 8 - DNA, 24 bp, Bacillus anthracis
cccagaacacgtgcacatcgtaga

SEQ ID NO: 9 - DNA, 11 bp, Bacillus anthracis
ttggatatggg

SEQ ID NO: 10 - DNA, 17 bp, Bacillus anthracis
ttggatcgaattatggg